(19) United States
(12) Patent Application Publication
(10) Pub. No.: US 2026/0249940 A1
(43) Pub. Date: Aug. 27, 2026

(54) ACTUATOR MODULE OF DROPPER SEATPOST

(71) Applicant: HSIN LUNG ACCESSORIES CO., LTD., Hsin-Chu Hsien (TW)

(72) Inventor: Hsueh-Sen LIAO, Hsin-Chu Hsien (TW)

(21) Appl. No.: 19/466,702

(22) Filed: Feb. 2, 2026

(30) Foreign Application Priority Data
Feb. 27, 2025 (TW) 114202062

(51) Int. Cl. B62J 1/08

(52) U.S. Cl. CPC B62J 1/08; B62J 2001/085

(57) ABSTRACT

Provided is a dropper seatpost having a seat tube and a seatpost sleeved within the seat tube. When adjusting the height of the seatpost, a motor of an actuator module is used to rotate a track stud, and a guide rod, constrained by a linear track and a through hole, causes a pushing sleeve to undergo linear movement, thereby driving a valve tip of a valve rod to generate linear displacement and switch a fluid-passage state within a valve seat. As a result, the seatpost is able to move upward or downward relative to the seat tube, thereby achieving height adjustment.

### PRIORITY CLAIM

This application claims priority to R.O.C. Utility Model Application No. 114202062 filed Feb. 27, 2025, the entirety of which is incorporated herein by reference.

### BACKGROUND OF THE INVENTION

### 1. Field of the Invention

The present invention relates to an improved dropper seatpost, and more particularly to an actuator module configured to control the vertical raising and lowering of a bicycle seatpost, thereby achieving smooth operation in use and providing high stability during adjustment.

### 2. Description of Related Art

Bicycles are a commonly used means of transportation. Their power source comes from pedaling by human force and does not need electricity or gasoline, making them very environmentally friendly and suitable for serving as a general tool of transportation or a leisure sports equipment.

Generally, a bicycle saddle is mounted above a rear portion of a bicycle frame by means of a seatpost. In order to accommodate riders of different body sizes, a height-adjusting device is typically provided on the seatpost to adjust the height of the saddle. The height-adjusting device is disposed between the seatpost and a saddle support tube, and operates by linear displacement to cause a relative positional change therebetween, thereby achieving height adjustment. Such height-adjusting devices may be broadly classified, according to the type of driving force employed, into mechanical types, pneumatic/hydraulic types, and hybrid types. The mechanical type utilizes actuation generated by certain mechanical structural parts to adjust the relative height position between the seatpost and the saddle support tube. The pneumatic/hydraulic type employs actuation generated by a pneumatic component, a hydraulic component, or a combination thereof, to adjust the relative height position between the seatpost and the saddle support tube. The hybrid type combines structural features of both the mechanical type and the pneumatic/hydraulic type to generate actuation for adjusting the relative height position between the seatpost and the saddle support tube.

Regardless of whether the above-mentioned height-adjusting devices are of the mechanical type, pneumatic/hydraulic type, or hybrid type, each is provided with a braking unit for selectively enabling a height-adjustable state by opening the height-adjusting device, and for fixing the device at a predetermined height by closing a control switch. In such conventional braking units, a steel cable, a hydraulic hose, or an electrical circuit is used to control displacement of a valve rod, thereby opening or closing fluid passages within a piston seat and further controlling the raising and lowering of the seatpost relative to the seat tube. However, manufacturers encounter considerable difficulty when routing steel cables, hydraulic hoses, or electrical circuits within the limited space of a bicycle frame, and such routing may even interfere with the installation of other components. As a result, the practical applicability of these conventional designs is relatively low.

Accordingly, another conventional mechanism has been proposed, in which adjustment of the seatpost height is primarily achieved by controlling activation of a motor via wireless transmission, such that a control lever, when driven by the motor, pushes a valve rod to generate linear displacement and thereby switches a fluid-flow communication state within a valve seat. Specifically, when adjustment of the saddle height is desired, an output shaft of the motor is extended and, through a cam block, pushes the control lever upward. The control lever then undergoes angular deflection and pushes the valve rod upward to switch the fluid-flow communication state within the valve seat, thereby forcing the fluid passages within the valve seat into an open state. At this time, the rider may further adjust the saddle height according to individual needs through linear displacement of the seatpost relative to the seat tube. However, although this conventional mechanism resolves the drawbacks associated with cable routing, actuation of the valve rod still requires a certain pushing force. Because the cam block contacts and pushes the valve rod from only a single side while bearing such pushing force, the force distribution on the cam block is uneven and readily causes tilting. As a result, after prolonged use, the valve rod may not be reliably actuated, causing the entire height-adjusting device to become inoperative.

### SUMMARY OF THE INVENTION

In view of the foregoing, the present invention provides an improved dropper seatpost, and more particularly to an actuator module configured to control the vertical raising and lowering of a bicycle seatpost, thereby achieving smooth operation in use and providing high stability during adjustment.

In an aspect provided herein is an actuator module for use in a dropper seatpost having a seat tube and a seatpost axially movably sleeved within the seat tube, and further comprising a control valve assembly and an actuator module. The control valve assembly comprises a valve seat and a valve rod disposed within the seat tube, and the valve rod has a top end axially movably inserted into the valve seat and a bottom end provided with a valve tip. The actuator module is adapted to push the valve tip so as to switch the fluid-passage state in the valve seat, thereby allowing the seatpost to move upward or downward relative to the seat tube. The actuator module comprising: a pushing sleeve, a limiting sleeve, a track stud, at least one guide rod, and a motor, wherein the track stud is formed with at least one arc-shaped track for receiving the guide rod, and the limiting sleeve is sleeved over the track stud and formed with at least one linear track for receiving the guide rod, and the pushing sleeve is sleeved over the limiting sleeve and disposed below the valve tip, and the pushing sleeve is formed with at least one through hole for receiving the guide rod, and the motor is adapted to drive the track stud to rotate, causing the guide rod to travel along the at least one arc-shaped track while being concurrently constrained by the at least one linear track and the through holes to move axially, thereby causing the pushing sleeve to undergo linear movement and, in turn, push the valve tip.

According to the preferred embodiments, the actuator module further comprises a signal transmitting device having an activation switch and a signal transmitter connected to the activation switch; and a signal receiving device having a circuit board and a signal receiver, wherein the circuit board is electrically connected to the motor, and the signal receiver is disposed on the circuit board and electrically connected to the signal transmitter.

According to the preferred embodiments, the signal transmitting device and the signal receiving device are connected by a wireless connection or a wired connection.

According to the preferred embodiments, the motor comprises a drive shaft connected to the track stud.

According to the preferred embodiments, the actuator module comprises two guide rods, and the track stud is formed with two arc-shaped tracks on its outer periphery with same inclination.

According to the preferred embodiments, the pushing sleeve is further formed with at least one through slot in communication with the through hole, such that the through hole is open to an exterior of the pushing sleeve via the through slot.

According to the preferred embodiments, the pushing sleeve further comprises a plurality of plate members assembled together, and each of the plurality of plate members is formed with the at least one through hole.

According to the preferred embodiments, the pushing sleeve comprises at least one through slot and a support plate assembled at the through slot, with the through hole being defined by an interface between the support plate and the through slot.

According to the preferred embodiments, the actuator module further comprises a sleeve body and a base body assembled together, wherein the sleeve body is sleeved over the pushing sleeve and formed with a threaded hole configured to lock the valve rod in position, and the base body being configured to accommodate the motor.

According to the preferred embodiments, the sleeve body comprises an assembly portion configured to be assembled to the seat tube.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a perspective structural diagram of the dropper seatpost according to the invention;

FIG. 2 is a perspective structural diagram of the actuator module according to the first embodiment of the invention;

FIG. 3 is an exploded structural diagram of the actuator module according to the first embodiment of the invention;

FIG. 4 is a schematic structural view of the actuator module according to the first embodiment of the invention;

FIG. 5 is an exploded structural diagram of the actuator module according to the second embodiment of the invention;

FIG. 6 is a schematic structural view of the actuator module according to the second embodiment of the invention;

FIG. 7 is a perspective structural diagram of the actuator module according to the third embodiment of the invention;

FIG. 8 is an exploded structural diagram of the actuator module according to the third embodiment of the invention; and

FIG. 9 is a schematic structural view of the actuator module according to the third embodiment of the invention.

### DETAILED DESCRIPTION OF THE INVENTION

In order to facilitate the examiner's understanding of the technical features, content and advantages of the invention and the efficacies it can achieve, the invention will be described in detail as follows in the form of embodiments and with reference to the accompanying drawings. The drawings used herein are merely for the purpose of illustration and supplement for the invention, and may not be the true proportions and precise configurations after the invention is implemented. Therefore, relationships between the proportions and configurations of the attached drawings should not be used to interpret or limit the scope of claims in the actual implementation.

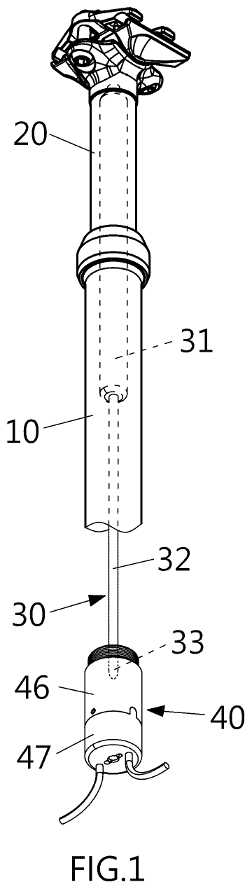

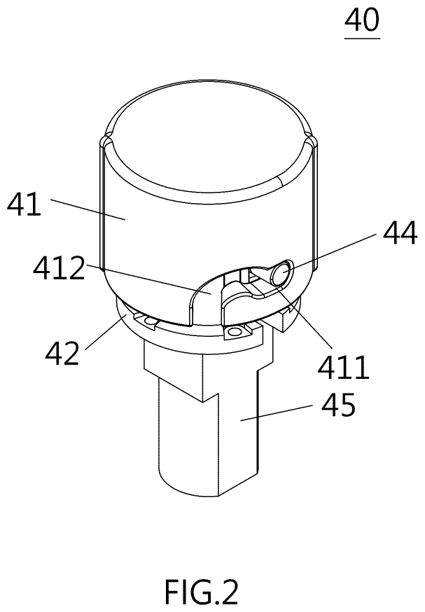

FIG. 1 is a perspective structural diagram of the dropper seatpost according to the invention, and FIG. 2 is a perspective structural diagram of the actuator module according to the first embodiment of the invention. As disclosed herein, the dropper seatpost comprises a seat tube 10 and a seatpost 20 axially movably sleeved within the seat tube 10. A top end of the seatpost 20 is configured for mounting a saddle (not shown). A bottom end of the seatpost 20 is sleeved within the seat tube 10 from a top end of the seat tube 10 and is movable upward and downward along an axial direction of the seat tube 10. The dropper seatpost further comprises a control valve assembly 30 and an actuator module 40. The control valve assembly 30 includes a valve seat 31 and a valve rod 32. The valve seat 31 is fixed within the seatpost 20. The valve rod 32 is disposed within the seat tube 10, with a top end thereof inserted into the valve seat 31. A bottom end of the valve rod 32 is provided with a valve tip 33 for switching a fluid-passage state in the valve seat 31. The actuator module 40 is adapted to push the valve tip 33 of the valve rod 32 so as to switch the fluid-passage state in the valve seat 31, thereby allowing the seatpost 20 to move upward or downward relative to the seat tube 10.

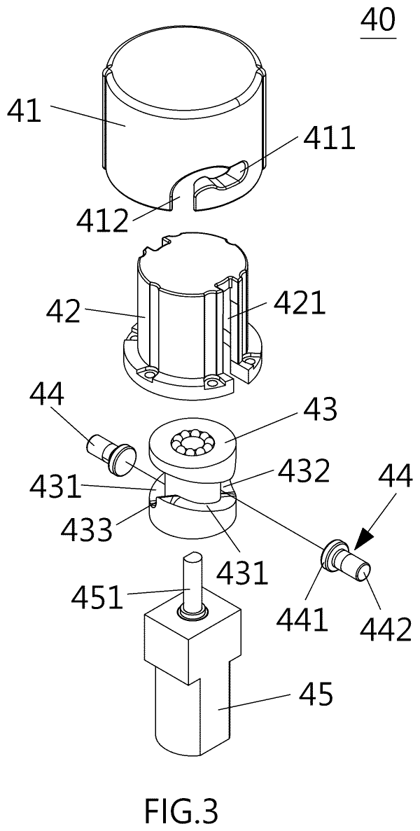

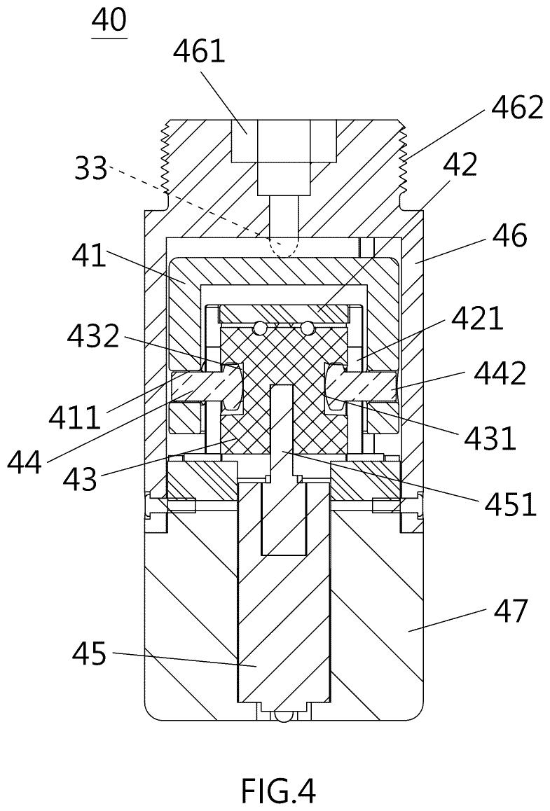

A gist of the invention is that the actuator module 40, as shown in FIGS. 3 and 4, comprises a pushing sleeve 41, a limiting sleeve 42, a track stud 43, at least one guide rod 44, and a motor 45. The track stud 43 is formed with at least one arc-shaped track 431 for receiving the guide rod 44. The limiting sleeve 42 is sleeved over the track stud 43 and is formed with at least one linear track 421 for receiving the guide rod 44. The pushing sleeve 41 is sleeved over the limiting sleeve 42 and is disposed below the valve tip 33. The pushing sleeve 41 is formed with at least one through hole 411 for receiving the guide rod 44. The motor 45 is configured to rotate the track stud 43, thereby forcing the guide rod 44 to travel along the arc-shaped track 431; concurrently, the guide rod 44 is constrained by the linear track 421 of the limiting sleeve 42 and the through hole 411 of the pushing sleeve 41 to move axially along the linear track 421, causing the pushing sleeve 41 to undergo linear displacement and, in turn, actuate the valve tip 33.

In a preferred embodiment, the actuator module comprises two guide rods 44, and the track stud 43 is formed with two arc-shaped tracks 431, which are arranged on an outer periphery of the track stud 43 with the same inclination. One of the arc-shaped tracks 431 has a highest point connected to a lowest point of the other arc-shaped track 431 by a vertical surface 433, and the one arc-shaped track 431 has a lowest point connected to a highest point of the other arc-shaped track 431 by another vertical surface 433, such that the two guide rods 44 respectively and concurrently move along the two arc-shaped tracks 431.

The actuator module 40 further comprises a sleeve body 46 and a base body 47 assembled together. During assembly, each of the two guide rods 44 is provided at one end thereof with a larger-sized head portion 441, which is respectively engaged with a corresponding groove portion 432 predefined in the arc-shaped tracks 431. An opposite end of each guide rod 44 has a smaller-diameter rod portion 442 that is exposed from the arc-shaped track 431. The limiting sleeve 42 is then sleeved over the track stud 43, such that the rod portions 442 of the guide rods 44 extend into the linear tracks 421, wherein the linear tracks 421 extend along an extending direction of the valve rod 32. The motor 45 is pre-positioned within the base body 47, after which the limiting sleeve 42 is fixed to the base body 47, and a drive shaft 451 of the motor 45 is connected to the track stud 43.

The pushing sleeve 41 is then sleeved over the limiting sleeve 42, while allowing the guide rods 44 to extend into the through holes 411. In the first embodiment illustrated, the pushing sleeve 41 further comprises at least one through slot 412, which communicates with the through hole 411, such that the through hole 411 is open to an exterior of the pushing sleeve 41 via the through slot 412. This configuration allows the rod portion 442 of the guide rod 44 to be positioned at the through hole 411 by sliding from outside the pushing sleeve 41 into the through hole 411 along the through slot 412. Finally, the sleeve body 46 is sleeved over the pushing sleeve 41 and fixedly assembled with the base body 47. The sleeve body 46 is formed with a threaded hole 461 for allowing the valve rod 32 to extend therethrough and be fixed in position above the pushing sleeve 41. The sleeve body 46 further comprises an assembly portion 462 configured to be assembled to the seat tube 10.

The invention further comprises a signal transmitting device and a signal receiving device. The signal transmitting device (not shown) includes an activation switch and a signal transmitter connected to the activation switch, wherein a bicycle handlebar is a preferred mounting location for the activation switch. The signal receiving device (not shown) is installed within the sleeve body 46 or the base body 47, and includes a circuit board (not shown) and a signal receiver (not shown). The circuit board is electrically connected to the motor 45, and the signal receiver is disposed on the circuit board and electrically connected to the signal transmitter (not shown). The signal transmitting device and the signal receiving device may be connected via a wireless connection or a wired connection, such that the motor 45 may be controlled to operate by either wireless or wired control.

When adjustment of the saddle height is desired, the activation switch is first pressed downward to control the signal transmitter to transmit a signal to the signal receiver. The circuit board then controls the motor 45 to start operation in response to the signal received by the signal receiver. When the motor 45 is actuated, the drive shaft 451 rotates and drives the track column 43 to rotate, causing the guide rods 44 to travel along the arc-shaped tracks 431 while being concurrently constrained by the linear tracks 421 of the limiting sleeve 42 and the through holes 411 to move axially, thereby converting rotational motion into linear displacement of the pushing sleeve 41, which in turn pushes the valve tip 33 upward to open the fluid passages within the valve seat 31. At this time, the rider may further adjust the saddle height according to individual needs through linear displacement of the seatpost 20 relative to the seat tube 10.

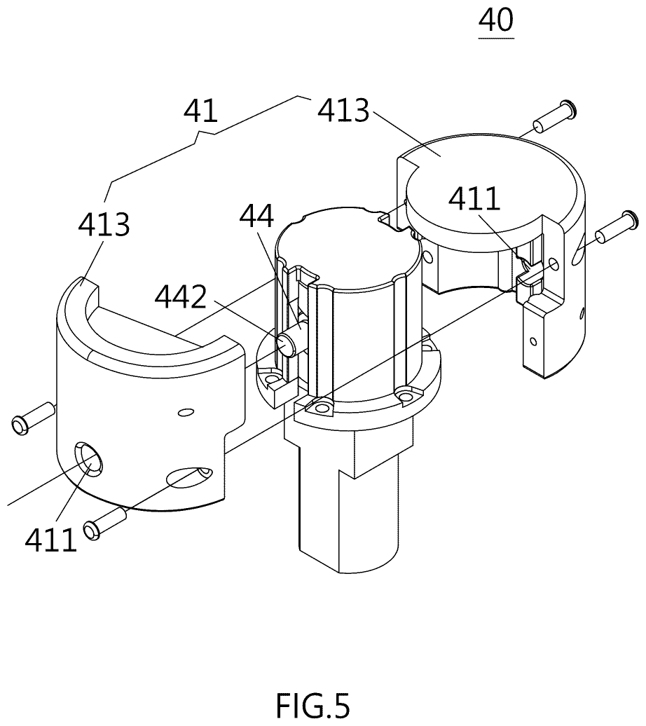

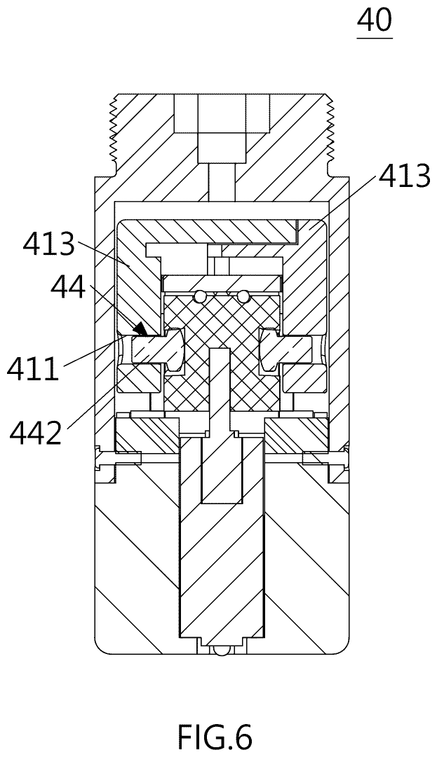

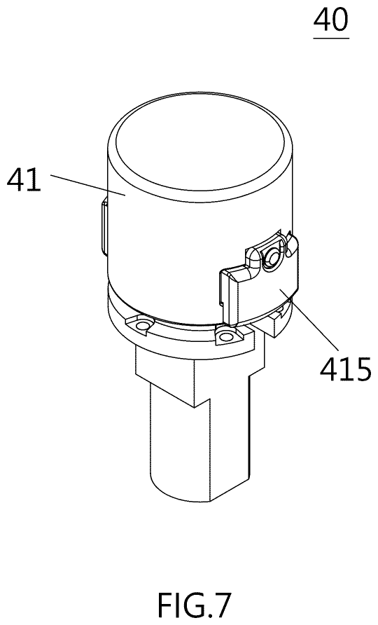

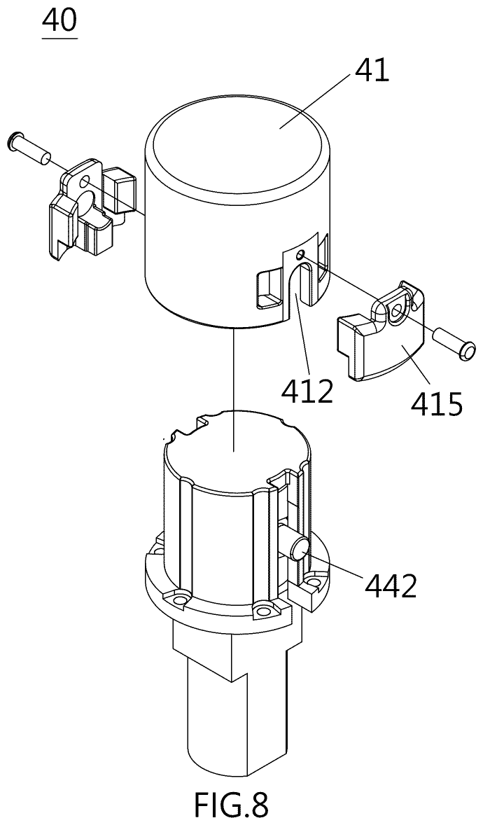

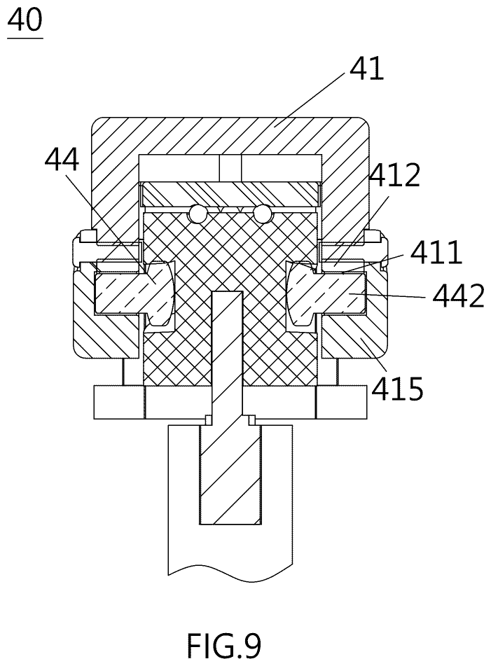

Furthermore, as shown in a second embodiment illustrated in FIGS. 5 and 6, the pushing sleeve 41 may further comprise a plurality of plate members 413 assembled together, and each of the plate members 413 is formed with the through hole 411. Alternatively, as shown in a third embodiment illustrated in FIGS. 7 to 9, the pushing sleeve 41 is formed with at least one through slot 412 and a support plate 415, wherein the support plate 415 is assembled at the through slot 412, and the through hole 411 is defined by an interface between the support plate 415 and the through slot 412. The through holes 411 disclosed in the various embodiments described above are each configured to receive the rod portion 442 of the guide rod 44 without interfering with linear displacement of the pushing sleeve 41.

In summary, the invention provides an improved and feasible dropper seatpost. While the invention has been described with reference to the preferred embodiments above, it should be recognized that the preferred embodiments are given for the purpose of illustration only and are not intended to limit the scope of the invention and that various modifications and changes, which will be apparent to those skilled in the relevant art, may be made without departing from the spirit and scope of the invention.

I claim:

1. An actuator module for use in a dropper seatpost having a seat tube and a seatpost axially movably sleeved within the seat tube, and further comprising a control valve assembly and an actuator module, wherein the control valve assembly comprises a valve seat and a valve rod disposed within the seat tube, and the valve rod has a top end axially movably inserted into the valve seat and a bottom end provided with a valve tip, and wherein the actuator module is adapted to push the valve tip so as to switch the fluid-passage state in the valve seat, thereby allowing the seatpost to move upward or downward relative to the seat tube, the actuator module comprising:
a pushing sleeve, a limiting sleeve, a track stud, at least one guide rod, and a motor, wherein the track stud is formed with at least one arc-shaped track for receiving the guide rod, and the limiting sleeve is sleeved over the track stud and formed with at least one linear track for receiving the guide rod, and the pushing sleeve is sleeved over the limiting sleeve and disposed below the valve tip, and the pushing sleeve is formed with at least one through hole for receiving the guide rod, and the motor is adapted to drive the track stud to rotate, causing the guide rod to travel along the at least one arc-shaped track while being concurrently constrained by the at least one linear track and the at least one through hole to move axially, thereby causing the pushing sleeve to undergo linear movement and, in turn, push the valve tip.

2. The actuator module according to claim 1, further comprising:
a signal transmitting device having an activation switch and a signal transmitter connected to the activation switch; and
a signal receiving device having a circuit board and a signal receiver, wherein the circuit board is electrically connected to the motor, and the signal receiver is disposed on the circuit board and electrically connected to the signal transmitter.

3. The actuator module according to claim 2, wherein the signal transmitting device and the signal receiving device are connected by a wireless connection or a wired connection.

4. The actuator module according to claim 2, wherein the motor comprises a drive shaft connected to the track stud.

5. The actuator module according to claim 4, wherein the actuator module comprises two guide rods, and the track stud is formed with two arc-shaped tracks on its outer periphery with same inclination.

6. The actuator module according to claim 4, wherein the pushing sleeve is further formed with at least one through slot in communication with the through hole, such that the through hole is open to an exterior of the pushing sleeve via the through slot.

7. The actuator module according to claim 4, wherein the pushing sleeve further comprises a plurality of plate members assembled together, and each of the plurality of plate members is formed with the at least one through hole.

8. The actuator module according to claim 4, wherein the pushing sleeve comprises at least one through slot and a support plate assembled at the through slot, with the through hole being defined by an interface between the support plate and the through slot.

9. The actuator module according to claim 4, further comprising a sleeve body and a base body assembled together, wherein the sleeve body is sleeved over the pushing sleeve and formed with a threaded hole configured to lock the valve rod in position, and the base body being configured to accommodate the motor.

10. The actuator module according to claim 9, wherein the sleeve body comprises an assembly portion configured to be assembled to the seat tube.
